(19) United States
(12) Patent Application Publication
(10) Pub. No.: US 2008/0159302 A1
(43) Pub. Date: Jul. 3, 2008

(54) Network Communication Equipment with PPPoE Bridging Function

(75) Inventors: JianMing Tu, Shanghai (CN); JinShan Xiong, Shanghai (CN); Jingyong Xia, Shanghai (CN)

Correspondence Address: PATENT LAW GROUP LLP, 2635 NORTH FIRST STREET, SUITE 223, SAN JOSE, CA, 95134, US

(73) Assignee: ArcSoft (Shanghai) Technology Company, LTD, Shanghai (CN)

(21) Appl. No.: 11/618,738

(22) Filed: Dec. 30, 2006

(51) Int. Cl. H04L 12/28

(52) U.S. Cl. 370/401

(57) ABSTRACT

A method is provided for a telephone gateway device to bridge a local area network (LAN) equipment and a broadband modem to a wide area network (WAN). The method includes starting a PPPoE server process to establish a first PPPoE connection to the LAN equipment connected at a LAN interface of the gateway device, starting a PPPoE client process to establish a second PPPoE connection to the broadband modem connected to a WAN interface of the gateway device, exchanging a first PPPoE negotiation information from the LAN equipment and a second PPPoE negotiation information from the broadband modem through the PPPoE server and the PPPoE client processes, establishing the first PPPoE connection to the LAN equipment at the LAN interface and the second PPPoE connection to the broadband modem at the WAN interface, and bridging the first and the second PPPoE connections.

### CROSS REFERENCE TO RELATED APPLICATIONS

This application is related to U.S. application Ser. No. 11/280,688 entitled “Using PSTN to Communicate IP Addresses for Point-to-Point Text, Voice, Video, or Data Communication,” Attorney Docket No. ARC-P152, which is commonly assigned and incorporated herein by reference.

This application is further related to (1) U.S. application Ser. No. ______, entitled “Point-to-Point Communication Using UPnP Protocol,” Attorney Docket No. ARC-P161, (2) U.S. application Ser. No. ______, entitled “Determining Pairings of Telephone Numbers and IP Addresses from Caching and Peer-to-Peer Lookup,” Attorney Docket No. ARC-P163, (3) U.S. application Ser. No. ______, entitled “Regional Service by Phone,” Attorney Docket No. ARC-P164, and (4) U.S. application Ser. No. ______, entitled “Using Second Channel to Communicate IP Address for Point-to-Point Text, Voice, Video, or Data communication,” Attorney Docket No. ARC-P165, which are concurrently filed, commonly assigned, and incorporated herein by reference.

### FIELD OF INVENTION

This invention relates to network equipment and more specifically to a network equipment with PPPoE bridging function in a local network for Voice over Internet Protocol (VoIP) telephony.

### DESCRIPTION OF RELATED ART

In U.S. patent application Ser. No. 11/280,688, entitled “Using PSTN to Communicate IP Addresses for Point-to-Point Text, Voice, Video, or Data Communication,” filed on Nov. 15, 2005, discloses a method for using the public switched telephone network (PSTN) to exchange Internet protocol (IP) addresses for point-to-point communication between two devices over a public computer network (e.g., the Internet). In one example, a first device uses the PSTN to send its IP address to a second device to setup a network connection over the public computer network. The second device then sends a network connection request to the first device over the public computer network using the IP address. Once the network connection has been established, the first and the second devices exchange data packets carrying text, voice, video, or other communications data between their users.

### BRIEF DESCRIPTION OF THE DRAWINGS

FIG. 1 illustrates a system for point-to-point communication over a wide area network in one embodiment of the invention.

FIG. 2 illustrates a local area network in the system of FIG. 1 in one embodiment of the invention.

FIG. 3 illustrates an alternative local area network in the system of FIG. 1 in one embodiment of the invention.

FIG. 4 illustrates a hardware view of a telephone gateway device with PPPoE bridging function in the local area network of FIG. 3 in one embodiment of the invention.

FIG. 5 illustrates a software view of the telephone gateway device in the local area network of FIG. 3 in one embodiment of the invention.

FIG. 6 is a flowchart of a method for the telephone gateway device of FIGS. 4 and 5 to provide PPPoE bridging in one embodiment of the invention.

FIG. 7 is a flowchart of a method for the telephone gateway device of FIGS. 4 and 5 to provide on-demand PPPoE bridging after no data is exchanged for an extended period of time in one embodiment of the invention.

FIG. 8 is a flowchart of a method for the telephone gateway device of FIGS. 4 and 5 to provide on-demand PPPoE bridging after the PPPoE connection is broken in one embodiment of the invention.

Use of the same reference numbers in different figures indicates similar or identical elements.

### SUMMARY

In one embodiment of the invention, a method is provided for a telephone gateway device to bridge a local area network (LAN) equipment and a broadband modem to a wide area network (WAN). The method includes starting a PPPoE server process to establish a first PPPoE connection to the LAN equipment connected at a LAN interface of the gateway device, starting a PPPoE client process to establish a second PPPoE connection to the broadband modem connected to a WAN interface of the gateway device, exchanging a first PPPoE negotiation information from the LAN equipment and a second PPPoE negotiation information from the broadband modem through the PPPoE server and the PPPoE client processes, establishing the first PPPoE connection to the LAN equipment at the LAN interface and the second PPPoE connection to the broadband modem at the WAN interface, and bridging the first and the second PPPoE connections.

### DETAILED DESCRIPTION

Point to Point Protocol over Ethernet (PPPoE) is a standard protocol that specifies how a host personal computer (PC) interacts with a broadband modem (i.e. xDSL, cable, wireless, etc.) to access the Internet through an Internet Service Provider (ISP).

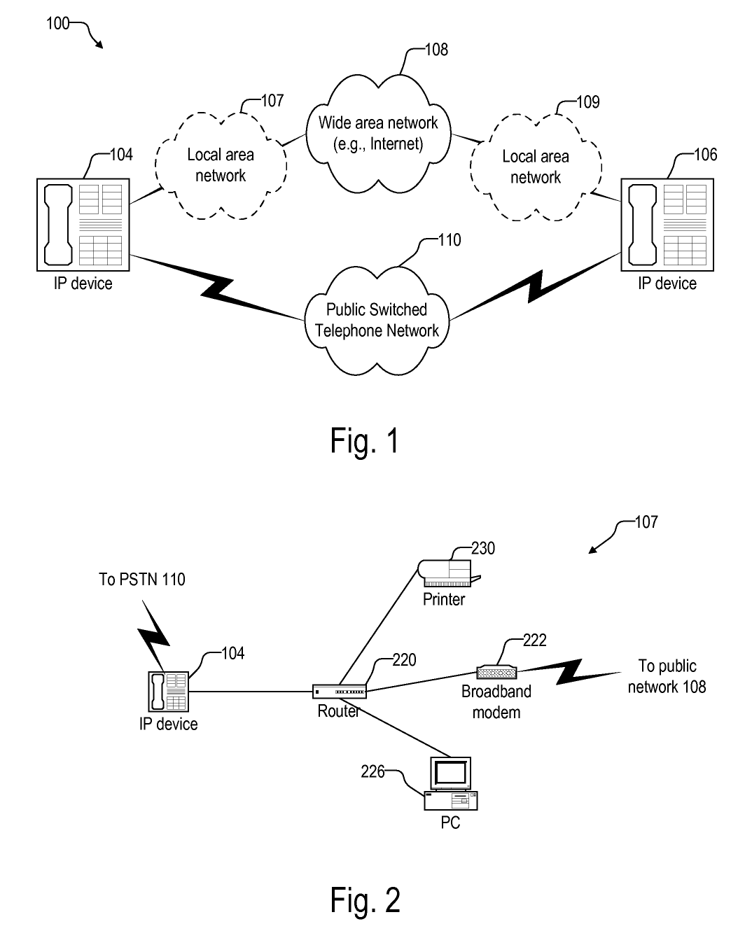

FIG. 1 illustrates a system 100 for point-to-point communication between IP devices 104 and 106 in one embodiment of the invention. Devices 104 and 106 are connected by a public wide area network (WAN) 108 (e.g., the Internet) for exchanging data packets through a network connection. Devices 104 and 106 may also be connected by a public switched telephone network (PSTN) 110 to exchange public IP addresses to establish the network connection over public computer network 108. In some scenarios, device 104 is connected by a local area network (LAN) 107 to WAN 108, and device 106 is connected by LAN 109 to WAN 108.

FIG. 2 illustrates LAN 107 in one embodiment of the invention. LAN 107 includes a router 220 for connecting various components in LAN 107 such as IP device 104, a broadband modem 222, a PC 226, and a printer 230. Broadband modem 222 (e.g., xDSL, cable, and wireless) connects LAN 107 to WAN 108. As described in U.S. patent application Ser. No. 11/280,688, it becomes difficult for devices 104 and 106 to establish point-to-point communication when at least one device is located behind a LAN because at least one device would not have a public IP address.

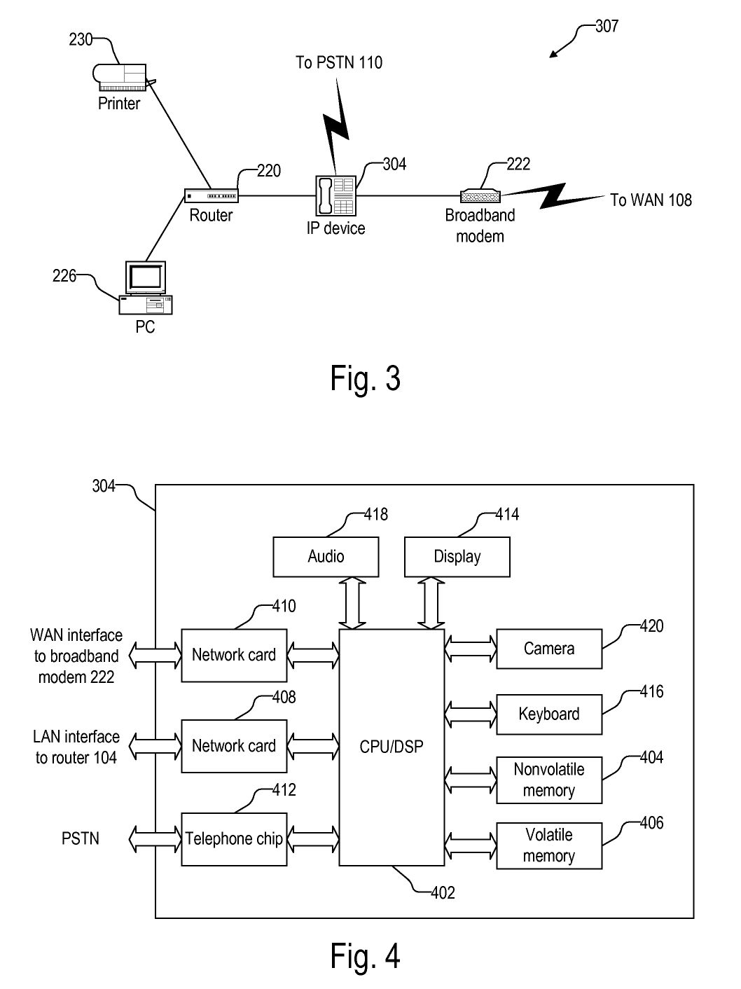

FIG. 3 illustrates a LAN 307 as an alternative to LAN 107 in one embodiment of the invention. In LAN 307, a VoIP telephone gateway device 304 is connected between router 220 and broadband modem 222. More specifically, VoIP telephone gateway 304 has a LAN Ethernet interface connected to the broadband Ethernet interface of router 220 in place of broadband modem 222. In essence, VoIP telephone gateway 304 represents itself as a broadband modem to router 220. Gateway device 304 also has a WAN Ethernet interface connected to the LAN Ethernet interface of broadband modem 222. VoIP telephone gateway 304 further has a telephone jack connected to PSTN 110. Note that personal computer 226 and printer 230 remain connected to router 220. Alternatively, personal computer 226 is simply connected to VoIP telephone gateway 304 without router 220.

VoIP telephone gateway 304 serves as a PPPoE bridge between router 220 and broadband modem 222. VoIP telephone gateway 304 also serves as an IP telephone device for communicating with another VoIP telephone gateway. By locating VoIP telephone gateway 304 before router 220, VoIP telephone gateway 304 is able to obtain the public IP address and establish point-to-point communication with another VoIP device.

FIG. 4 illustrates a hardware view of VoIP telephone gateway 304 in one embodiment of the invention. VoIP telephone gateway 304 has the form factor of a telephone or a videophone. VoIP telephone gateway device 304 includes a central processing unit (CPU) or digital signal processor (DSP) 402 that executes PPPoE bridging software and VoIP software loaded from nonvolatile memory 404 to volatile memory 406. CPU 402 uses a network card 408 to access LAN 107 through a LAN interface. CPU 402 uses a network card 410 to access broadband modem 222 through a WAN interface. CPU 402 uses a telephone chip 412 to access PSTN 110. Telephone chip 412 includes a modem for generating and receiving signals over PSTN 110. For text, voice, and video communications, CPU 402 may be further connected to peripherals including a display 414, a keypad or keyboard 416, microphone and speaker 418, and a camera 420.

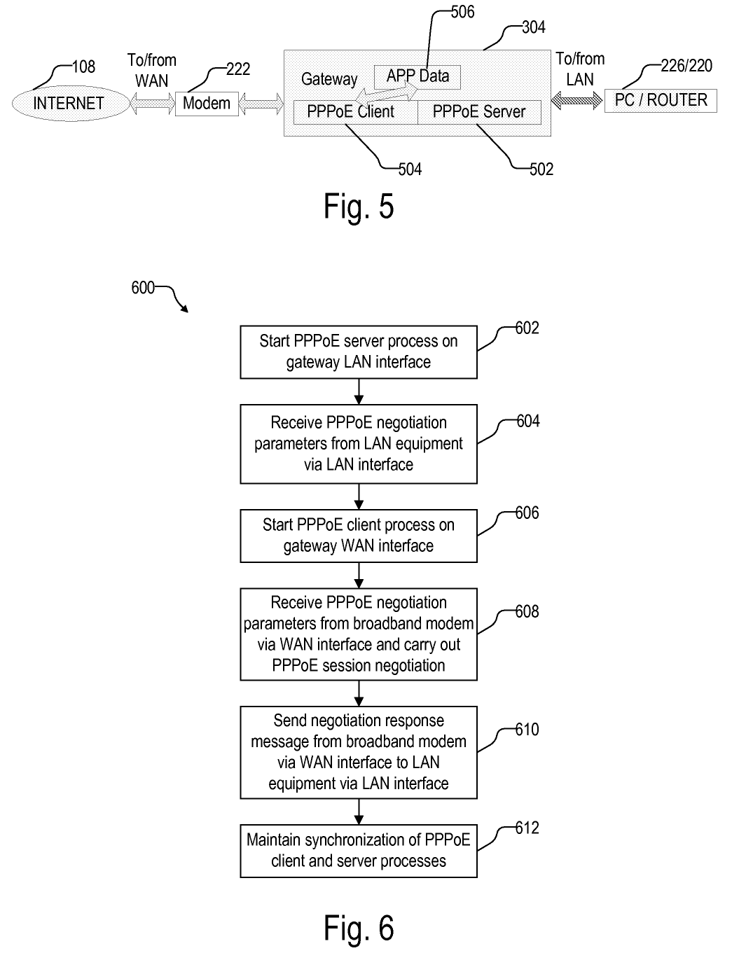

FIG. 5 illustrates a software view of VoIP telephone gateway 304 in one embodiment of the invention. VoIP telephone gateway 304 has a PPPoE server process 502 for communicating with a LAN equipment, and a PPPoE client process 504 for communicating with broadband modem 222. The LAN equipment can be PC 226 directly connected to VoIP telephone gateway 304, router 220, or another device indirectly connected to VoIP telephone gateway 304 through router 220. VoIP telephone gateway 304 also has VoIP software 506 for communicating with another VoIP device over WAN 108.

FIG. 6 illustrates a method 600 for VoIP telephone gateway 304 to provide a PPPoE bridge between a LAN equipment and WAN 108 in one embodiment of the invention. As described above, the LAN equipment can be PC 226 directly connected to VoIP telephone gateway 304, router 220, or another device indirectly connected to VoIP telephone gateway 304 through router 220.

In step 602, VoIP telephone gateway 304 starts PPPoE server process 502 on the LAN interface connected to the LAN equipment. For more details regarding the PPPoE protocol, please refer to RFC 2516—A Method for Transmitting PPP over Ethernet (PPPoE) and RFC 1661—The Point-to-Point Protocol (PPP).

In step 604, PPPoE server 502 on VoIP telephone gateway 304 receives PPPoE negotiation parameters from the LAN equipment on the LAN interface. The negotiation parameters include PPPoE discovery and session phase messages, such as username and password with the ISP. VoIP telephone gateway device 304 stores the PPPoE negotiation parameters in memory for establishing future PPPoE connection.

In step 606, VoIP telephone gateway 304 starts a PPPoE client process on the WAN interface connected to broadband modem 222.

In step 608, PPPoE client process 504 on VoIP telephone gateway 304 receives PPPoE negotiation parameters from broadband modem 222 on the WAN interface. The negotiation parameters include PPPoE discovery phase messages. Note that broadband modem 222 originally receives the PPPoE negotiation parameters from the ISP. Using the PPPoE negotiation parameters from the LAN equipment, VoIP telephone gateway 304 negotiates a PPPoE session with broadband modem 222.

In step 610, VoIP telephone gateway 304 sends negotiation response information from broadband modem 222 to the LAN equipment through the LAN interface. At this point, PPPoE server process 502 of VoIP telephone gateway 304 has established one PPPoE connection with the LAN equipment at the LAN interface, and PPPoE client process 504 has established another PPPoE connection with broadband modem 222 at the WAN interface. The negotiation response information includes the IP address, subnet mask, default gateway, and DNS server. The LAN equipment uses the negotiation response information to access WAN 108.

In step 612, VoIP telephone gateway 304 maintains synchronization of the PPPoE server 502 and client 504 by passing the status of the PPPoE connections at the WAN and the LAN interfaces. For example, VoIP telephone gateway 304 sends a link down message to the LAN equipment when the PPPoE connection at the WAN interface is down.

After the PPPoE connection to WAN 108 has been established, other equipment (e.g., computer 226) in local area network 307 can also access WAN 108 through router 220. Furthermore, VoIP software 506 in VoIP telephone gateway 304 can use the PPPoE connection to communicate with another VoIP device over WAN 108 using the pubic IP address received during the PPPoE negotiation. Specifically, VoIP software 506 sends and receives packets through PPPoE client process 504 to another VoIP device. VoIP telephone gateway 304 uses a port map that to intercept data packets destined for VoIP software 506 and pass data packets destined for other devices in LAN 307 through router 220. Even if the original PPPoE connection is broken, VoIP software 506 can request PPPoE client process 504 to establish another PPPoE connection with WAN 108 using the saved PPPoE negotiation parameters stored in memory.

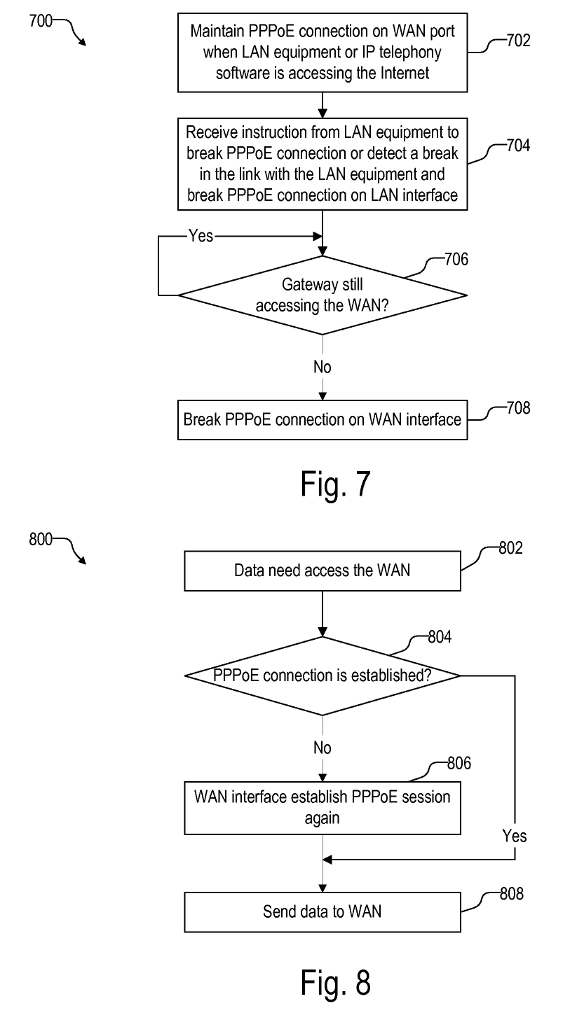

FIG. 7 illustrates a method 700 for gateway device 304 to provide on-demand PPPoE bridging between a LAN equipment and a broadband modem 222 after an PPPoE connection in one embodiment of the invention. As described above, the LAN equipment can be PC 226 directly connected to VoIP telephone gateway 304, router 220, or another device indirectly connected to VoIP telephone gateway 304 through router 220. Method 700 breaks the PPPoE connection to WAN 108 when neither the local area network nor IP telephony software 506 needs access to WAN 108. The PPPoE connection can be established through method 600 described above.

In step 702, gateway device 304 maintains the PPPoE connection on the WAN interface as long as the LAN equipment or VoIP software 506 is accessing WAN 108. Step 702 is followed by step 704.

In step 704, gateway device 304 receives an instruction from the LAN equipment to break the PPPoE connection or detects the link to the LAN equipment is down. In response, VoIP telephone gateway 304 breaks the PPPoE connection at the LAN interface but maintains the PPPoE connection at the WAN interface. In other words, VoIP telephone gateway 304 causes PPPoE server process 502 to break the PPPoE connection to the LAN equipment without causing PPPoE client process 504 to break the PPPoE connection to WAN 108. Step 704 is followed by step 706.

In step 706, VoIP telephone gateway 304 determines if there is a need to access WAN 108. There is a need to access WAN 108 when VoIP software 506 is still communicating with another device over WAN 108. There is also a need to access WAN 108 when any device connected through router 220 is still accessing WAN 108. If so, then step 706 repeats until there is not a need to access WAN 108. Thus, even if the PPPoE connection at the LAN interface is broken, VoIP software 506 or another device connected through router 222 can still access WAN 108. If VoIP software 506 is not accessing WAN 108, then step 706 is followed by step 708.

In step 708, VoIP telephone gateway 304 breaks the PPPoE connection on the WAN interface. More specifically, VoIP telephone gateway 304 causes PPPoE client process 504 to break the PPPoE connection to WAN 108.

FIG. 8 illustrates a method 800 for VoIP telephone gateway 304 to provide on-demand PPPoE bridging to broadband modem 222 after the PPPoE connection has been broken in one embodiment of the invention. Method 800 establishes the PPPoE connection to WAN 108 anytime VoIP software 506 or a LAN equipment needs to send or receive data over WAN 108 again. As described above, the LAN equipment can be PC 226 directly connected to VoIP telephone gateway 304, router 220, or another device indirectly connected to VoIP telephone gateway 304 through router 220.

In step 802, VoIP telephone gateway 304 detects VoIP software 506 or the LAN equipment needs to send or receive data over WAN 108. For example, the LAN equipment may wish to access a website on WAN 108). When VoIP software 506 needs to access WAN 108, VoIP telephone gateway 304 uses the stored the saved PPPoE negotiation parameters stored in memory. When the LAN equipment needs to access WAN 108, VoIP telephone gateway 304 will receive PPPoE negotiation parameters from the LAN equipment as described in step 604 (FIG. 6).

In step 804, VoIP telephone gateway 304 determines whether or not the PPPoE connection at the WAN interface is operating. If so, then step 804 is followed by step 808. If the PPPoE connection at the WAN interface is broken, then step 804 is followed by step 806.

In step 806, VoIP telephone gateway 304 reestablishes the PPPoE connection at the WAN interface as described in steps 606 to 612 (FIG. 6).

In step 808, VoIP telephone gateway 304 transfers the data to and from WAN 108.

Various other adaptations and combinations of features of the embodiments disclosed are within the scope of the invention. Numerous embodiments are encompassed by the following claims.

What is claimed is:

1. A method for a telephone gateway device to bridge a local area network (LAN) equipment and a broadband modem to a wide area network (WAN), comprising:
starting a PPPoE server process to establish a PPPoE connection at a LAN interface of the telephone gateway device to the LAN equipment, the LAN equipment being one of a computer and a router;
starting a PPPoE client process to establish a second PPPoE connection at a WAN interface of the telephone gateway device;
exchanging first PPPoE negotiation information from the LAN equipment and second PPPoE negotiation information from the broadband modem through the PPPoE server and the PPPoE client processes; and
establishing the PPPoE connection at the LAN interface and the PPPoE connection at the WAN interface.

2. The method of claim 1, further comprising:
exchanging data packets between the LAN equipment and WAN through the broadband modem.

3. The method of claim 2, further comprising:
breaking at least the PPPoE connection at the WAN interface;
receiving a request from the LAN equipment to access the WAN; and
reestablishing the PPPoE connection at the WAN interface for the LAN equipment to access the WAN.

4. The method of claim 2, further comprising:
saving the first PPPoE negotiation information in memory;
breaking at least the PPPoE connection at the WAN interface;
using the PPPoE client process to reestablish the PPPoE connection at the WAN interface with the saved first PPPoE negotiation information; and
using the PPPoE connection at the WAN interface for IP telephony communication with another device over the WAN.

5. The method of claim 1, further comprising synchronizing the PPPoE server process and the PPPoE client process.

6. The method of claim 2, wherein the LAN equipment is a router and another machine connected to the router uses the first PPPoE connection to access the WAN.

7. The method of claim 6, further comprising:
breaking the PPPoE connection at the LAN interface but maintaining the PPPoE connection at the WAN interface; and
continuing to provide WAN access to said another machine connected to the router through the telephone gateway device.
